(19) United States
(12) Patent Application Publication
(10) Pub. No.: US 2025/0221398 A1
(43) Pub. Date: Jul. 10, 2025

(54) Recreational Vehicle Pest Deterrent Device

(71) Applicants: Mirielle Pacquing, Sherman Oaks, CA (US); Darryl Markowski, Sherman Oaks, CA (US); Robert Thomas Toy, Sherman Oaks, CA (US)

(72) Inventors: Mirielle Pacquing, Sherman Oaks, CA (US); Darryl Markowski, Sherman Oaks, CA (US); Robert Thomas Toy, Sherman Oaks, CA (US)

(21) Appl. No.: 18/408,743

(22) Filed: Jan. 10, 2024

(51) Int. Cl. A01M 29/30

(52) U.S. Cl. CPC A01M 29/30

(57) ABSTRACT

A pest deterrent device is designed to be installed on a jack shaft of a recreational vehicle or camper and includes a body in the form of a collar. The body has a passage therein that is designed to receive and enclose a portion of the jack shaft. The body is divided into two sections that are pivotably connected together by a hinge structure. A locking arrangement is used to releasably lock the two sections together around the jack shaft. To install the pest deterrent device, the sections are moved apart from one another to open the body, the body is placed around the jack shaft, and then the two sections are moved back together to close the body around the jack shaft.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to pest deterrent devices and more particularly pertains to a new pest deterrent device for deterring or preventing pests from entering a recreational vehicle or camper. Recreational vehicles, often referred to as RVs, and campers are popular mechanisms for people to enjoy traveling and the outdoors. At this time it should be noted that any reference to a “recreational vehicle,” “camper,” or “RV” in this application should be understood as referring to all such vehicles or mechanisms or structures. RVs and campers are mobile either by themselves or towed by a vehicle. Such towable RVs and campers usually only have wheels on one end while the other end has a connecting structure to connect to a vehicles, such as a pickup truck. When towable RVs and campers are moved to a desired location, they are usually disconnected from the towing vehicle. The connecting end unsupported by the wheels is usually supported by a jack or stand, which is generally in the form of an elongated rod or pole connected to a foot. RVs and campers that can be driven by themselves usually are parked on their wheels. However, when such RVs are stored for longer periods of time when not in use, multiple jacks or stands can be used to lift the RV off of the wheels in order to maintain the wheels in good condition and minimize wear and tear due to the weight of the RV.

Unfortunately, since the RVs are often stored in areas without human activity or contact for substantial periods of time, or are temporarily situated in outdoor areas, such as wooded or forested areas, with larger populations of animals, the risk of pest infestation is increased. Animals such as mice, rats, squirrels, and similar creatures can enter the RV and settle in. Obviously, such infestations are not only unpleasant to the owner, but also could lead to substantial damage, which can be quite expensive, especially for high value vehicles like RVs.

One point of entry is at the above-mentioned jacks, which can be used by pests, such as mice, rats, squirrels, or similar creatures as an access route into the RV. Such animals can climb up the jack and eventually find their way into the RV or camper through rough small cracks and crevices. It therefore would be beneficial to the RV owner to have a way to prevent or deter such creatures from climbing up the jack, especially when the RV is unsupervised for long periods of time or located in areas with larger animal populations.

### (2) Description of Related Art Including Information Disclosed Under 37 CFR 1.97 and 1.98

The prior art relates to pest deterrent devices for different settings and uses, like ship moorings, bird feeders, and airplanes, but not for recreational vehicles or campers.

### BRIEF SUMMARY OF THE INVENTION

An embodiment of the disclosure meets the needs presented above by generally comprising a collar structure designed to clamp around a jack shaft of a recreational vehicle or camper. The pest deterrent device is in the shape of a disk or plate with a passage therein designed to accommodate the jack shaft therein. The pest deterrent device could comprise plastic or metal or other hard material. The pest deterrent device could have a generally cylindrical shape and measure about three to five inches in diameter, though larger or smaller sizes are contemplated by this disclosure. In accordance with at least one possible embodiment, the pest deterrent device could have a cylindrical base portion and a tapered or conical upper portion or an upper portion with one or more shoulders, such that the diameter of the pest deterrent device decreases from about three to five inches at the base portion to about two inches at the peak of the upper portion. The passage for the jack shaft is shaped to match the outer shape and contour of the jack shaft to promote a close fit. The passage may be rectangular, square, or circular, depending on the shape of the jack shaft to be protected. The pest deterrent device, in accordance with at least one embodiment, comprises at least two sections, such as two halves, that are either completely separate from one another or connected at a pivot or hinge section to permit the sections to be moved apart from one another. When installing the pest deterrent device on a jack, the sections are moved or pivoted apart from one another to allow the user to place the pest deterrent device around the jack shaft. Once placed in the desired position on the jack shaft, the user closes the pest deterrent device by moving the sections together about the jack shaft with the jack shaft inside the passage. In accordance with at least one possible embodiment, the pest deterrent device comprises a locking arrangement to lock the sections of the pest deterrent device together and onto the jack shaft. When the user wishes to remove the pest deterrent device, the user can undo the locking arrangement and remove the pest deterrent device.

The user can leave the pest deterrent device in place for as long as desired to deter pests from climbing the jack shaft. The diameter of the pest deterrent device is sufficient that animals, as they climb up the jack shaft, will be prevented or deterred from climbing further as they will not be able to bypass or get around the pest deterrent device. In addition, in accordance with at least one possible embodiment, the pest deterrent device can be substantially hollow or open-ended in the form of a cup or bowl or cylinder. When installed, the open end faces toward the ground. With this design, pests can climb up the jack shaft into the interior of the pest deterrent device, but ultimately they run into a closed surface with no means of getting around the barrier. This design further minimizes the possibility of the animal climbing around the pest deterrent device. In addition, this hollow design allows the pest deterrent device to accommodate a pin or similar structure projecting out of the jack shaft. Such pins are used to lock the jack shaft, which is adjustable, at a desired height. In accordance with at least one possible embodiment, the base portion of the pest deterrent device is hollow but the upper portion is solid, such that the upper portion can rest or be supported on the pin. Alternatively, the passage could be shaped such that the friction fit between the inner walls of the passage and the jack shaft is sufficient to hold the pest deterrent device in place regardless of whether or not a pin is present.

In accordance with at least one possible embodiment, the pest deterrent device can have smooth and/or rounded surfaces to further prevent animals from gripping and climbing on the pest deterrent device.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a pest deterrent device according to an embodiment of the disclosure.

FIG. 2 is a top perspective view of the pest deterrent device opened.

FIG. 3 is a bottom perspective view of the pest deterrent device.

FIG. 4 is a view of the pest deterrent device and a jack of a recreational vehicle or camper.

FIG. 5 is a side view of the pest deterrent device installed on a jack.

FIG. 6 is a side view of a recreational vehicle or camper and the pest deterrent device installed on a jack thereof.

FIG. 7 is a top perspective view of another embodiment of the pest deterrent device.

FIG. 8 is a view of the pest deterrent device shown in FIG. 7 installed on a jack.

### DETAILED DESCRIPTION OF THE INVENTION

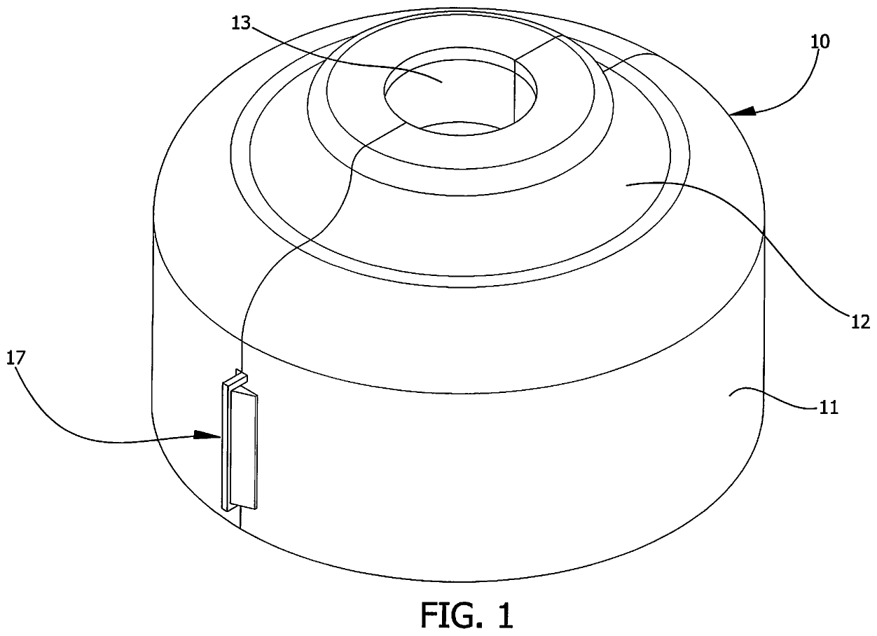

With reference now to the drawings, and in particular to FIGS. 1 through 8 thereof, a new pest deterrent device embodying the principles and concepts of an embodiment of the disclosure and generally designated by the reference numeral 10 will be described.

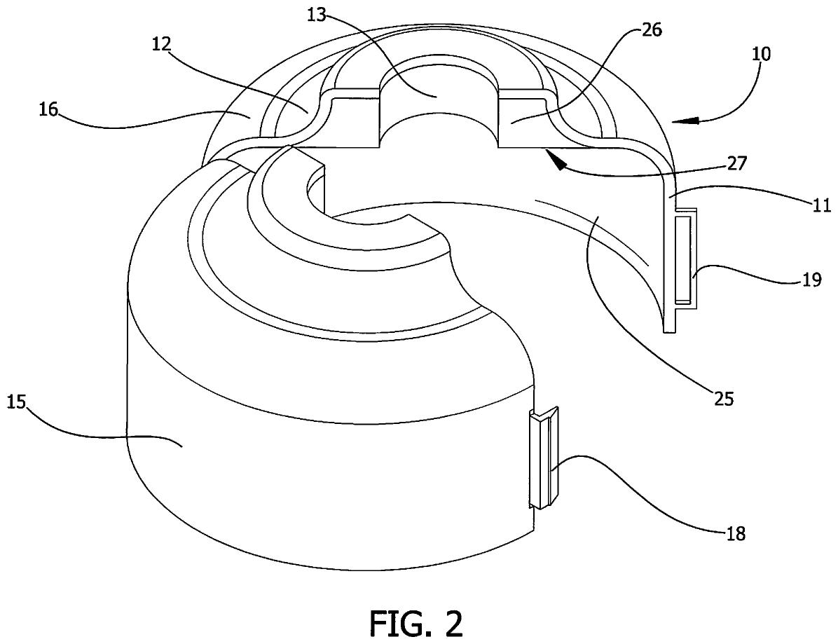

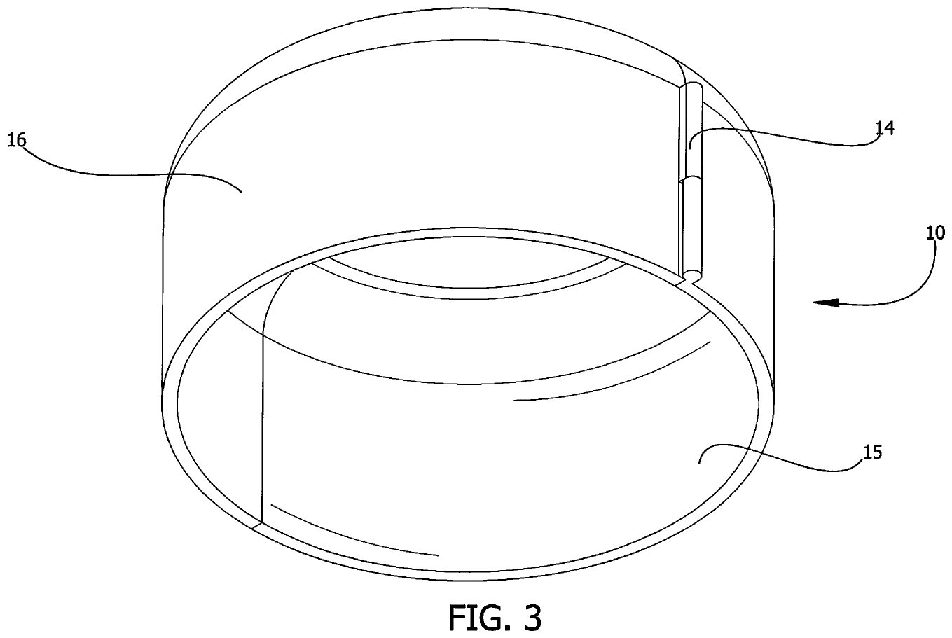

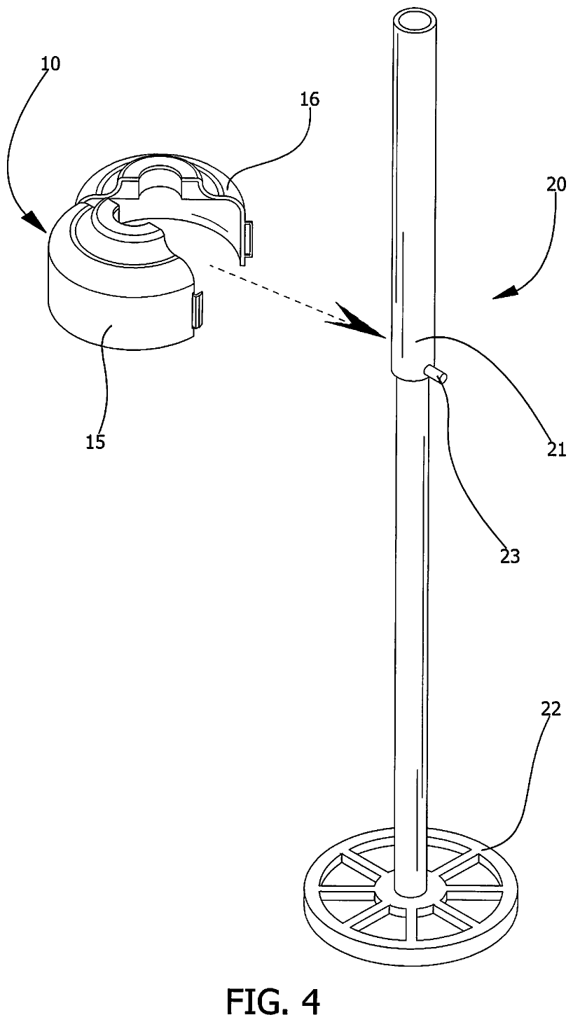

As best illustrated in FIGS. 1 through 10, the pest deterrent device 10 generally comprises a collar structure designed to clamp around a jack shaft of a recreational vehicle or camper. In accordance with at least one possible embodiment, the pest deterrent device 10 has a base portion 11 that is generally cylindrical and an upper portion 12 that is generally tapered or conical or comprises one or more shoulders, such that the diameter of the pest deterrent device 10 is greater at the base portion 11 than at the peak of the upper portion 12. A passage 13 for a jack shaft is located in the center of the pest deterrent device 10 and is shaped to match the outer shape and contour of the jack shaft to promote a close fit. The passage 13 may be rectangular, square, or circular, depending on the shape of the jack shaft to be protected. As best seen in FIG. 2, the pest deterrent device 10 comprises two sections, a first section 15 and a second section 16. As best seen in FIG. 3, the two sections 15, 16 are connected at a hinge 14 to permit the sections 15, 16 to be moved or pivoted apart from one another. As best seen in FIG. 4, when installing the pest deterrent device 10 on a jack 20, the sections 15, 16 are moved or pivoted apart from one another to allow the user to place the pest deterrent device 10 around the shaft 21 of the jack 20, which shaft 21 is connected to a foot 22 that rests on the ground or other support surface. Once placed in the desired position on the jack shaft 21, the user closes the pest deterrent device 10 by moving the sections 15, 16 together about the jack shaft 21 with the jack shaft 21 inside the passage 13. In accordance with at least one possible embodiment, the pest deterrent device 10 comprises a locking arrangement 17 to lock the sections 15, 16 of the pest deterrent device 10 together and onto the jack shaft 21. When the user wishes to remove the pest deterrent device 10, the user can undo the locking arrangement 17 and remove the pest deterrent device 10. As best seen in FIG. 2, one embodiment of the locking arrangement 17 is a snap-fit type of arrangement that comprises a locking tab 18 disposed on the first section 15, and a locking bracket 19 disposed on the second section 16. It should be understood that the positions of the locking tab 18 and locking bracket 19 could be reversed. The locking tab 18 is resiliently flexible and configured to be inserted into the locking bracket 19. The locking tab 18 has a retaining shoulder or projection that rests against the locking bracket 19 upon insertion to keep the pest deterrent device 10 in a closed, locked position. When the user wishes to remove the pest deterrent device 10, the user can simply depress the locking tab 18 to release the engagement with the locking bracket 19, thereby allowing the sections 15, 16 to be moved apart.

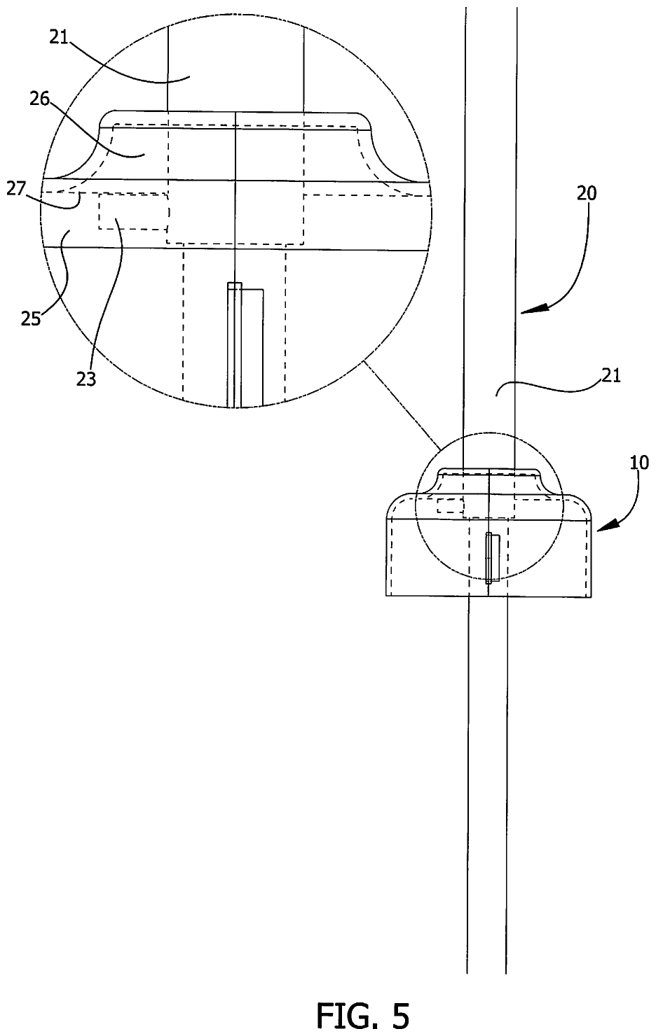

As can be seen in FIGS. 2 and 3, the pest deterrent device 10 can be substantially hollow or open-ended in the form of a cup or bowl or cylinder. The base portion 11 comprises an open or hollow section 25, the diameter of which is substantially greater than the diameter of the shaft 21 such that the edges and interior surface of the open section 25 are located a substantial distance from the shaft 21 to create the hollow interior space inside the base portion 11. The upper portion 12 comprises a closed or interior section 26 that surrounds and defines the passage 13. In contrast to the open section 25, the closed section 26 fits tightly or snugly around the shaft 21 so no animal can pass through the pest deterrent device 10. In addition, as seen in FIG. 5, when installed, the closed section 26 rests against and is supported on a pin 23 of the jack 20. Most jacks 20 are adjustable in height via a telescoping design. The pin 23 is used to lock the jack 20 at its desired height. The pest deterrent device 10 utilizes this pin 23 as a support so that the pest deterrent device 10 will not slide down the shaft 21 when installed. Since the closed section 26 is solid, it forms a shoulder surface 27 that contacts the pin 23, as seen in FIG. 5. The closed section 26 can be integrally formed as part of the upper portion 12, or can be formed as a separate piece attached to the upper portion 12, such as a plastic or rubber or resiliently elastic gasket or similar structure. Such a gasket could promote or form a sealing and/or friction fit with the shaft 21.

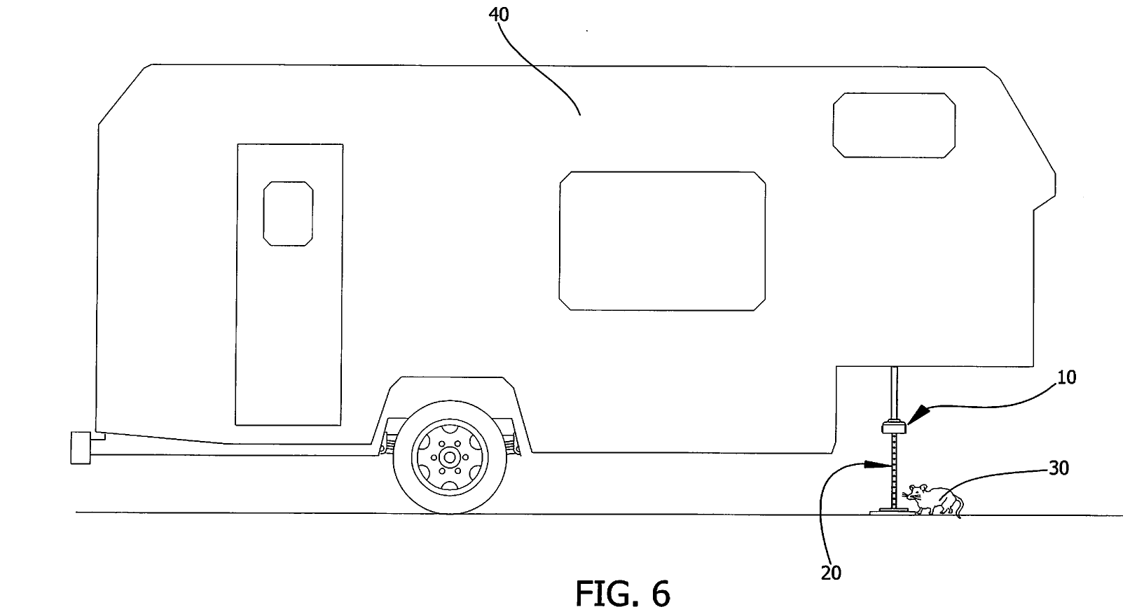

As seen in FIG. 6, when installed, the open section 25 of the pest deterrent device 10 faces toward the ground or toward the foot 22. With this design, an animal 30, such as a mouse or rat, desiring to enter a vehicle 40, such as a recreational vehicle or camper, can climb up the jack shaft 21 into the interior of the pest deterrent device 10, but ultimately runs into the shoulder surface 27 of the closed section 26 with no means of traveling further.

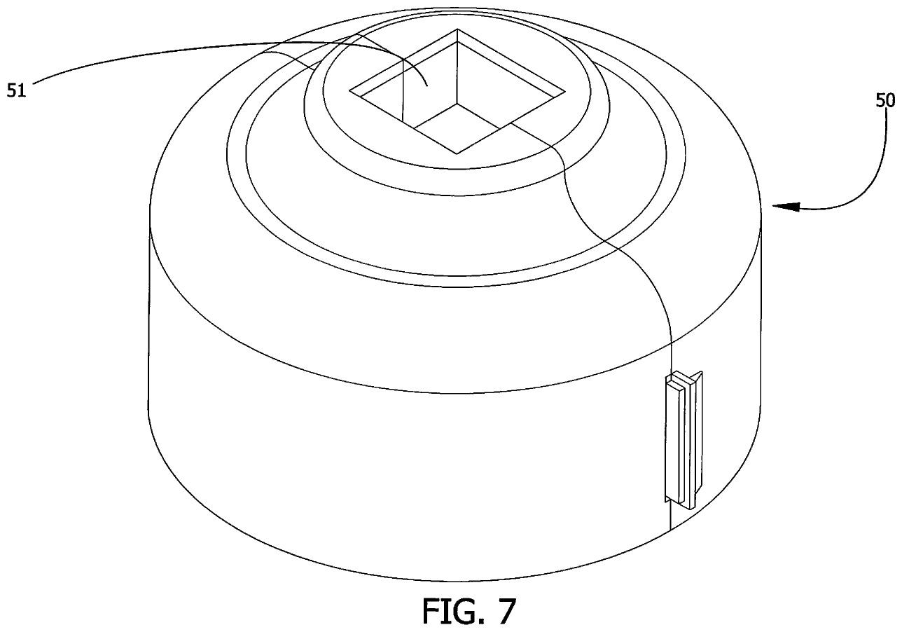

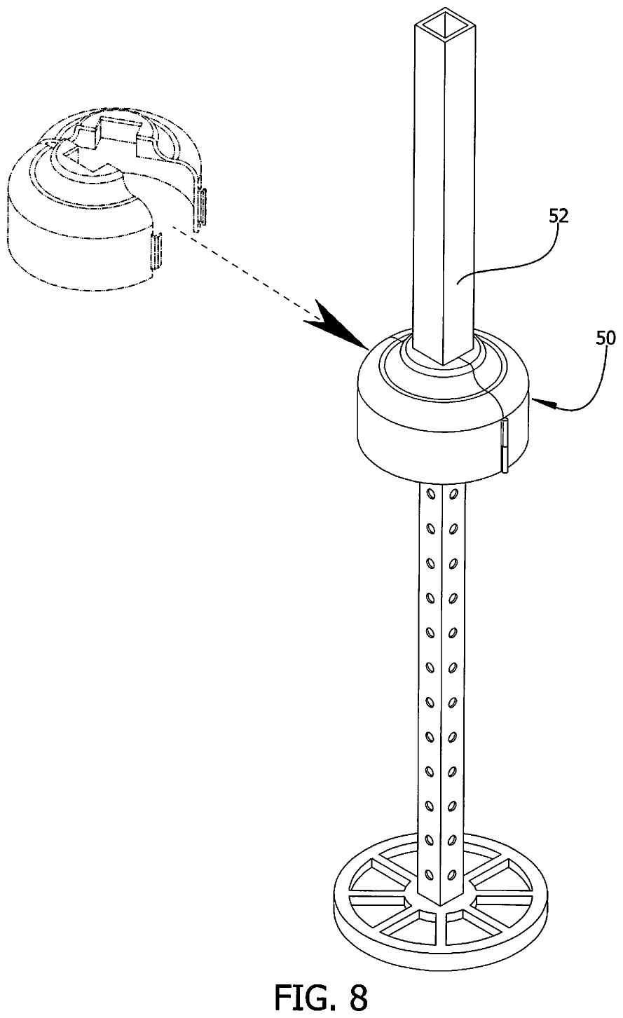

FIGS. 7 and 8 show an alternative embodiment, namely pest deterrent device 50, which differs from the embodiment shown in FIGS. 1-6 in that the pest deterrent device 50 comprises a passage 51 that has a square or rectangular shape designed to fit onto a shaft 52 that has a matching square or rectangular shape. All other components of the pest deterrent device 50 are the same as the pest deterrent device 10 having a passage 13 that is cylindrical or rounded, which are not marked in FIGS. 7 and 8 for convenience.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A pest deterrent device configured to be installed on a jack shaft of a recreational vehicle or camper, said pest deterrent device comprising:
a body being in the form of a collar and comprising a base portion and an upper portion;
said base portion being substantially cylindrical;
said upper portion being substantially tapered or conical or comprising one or more shoulder surfaces;
said upper portion comprising a passage configured to receive and enclose a portion of a jack shaft;
said body being divided into a first section and a second section pivotably connected together by a hinge structure to permit said first section and said second section to be moved apart from one another to open said body and then moved back together to close said body around a jack shaft; and
a locking arrangement being configured to lock together said first section and said second section to releasably lock said body around a jack shaft.

2. The pest deterrent device according to claim 1, wherein:
said locking arrangement comprises a locking tab disposed on said first section and a locking bracket disposed on said second section; and
said locking tab is configured to be inserted into said locking bracket in a snap-fit connection.

3. The pest deterrent device according to claim 2, wherein said base portion is substantially hollow and has an inner diameter substantially greater than the diameter of said passage.

4. The pest deterrent device according to claim 3, wherein said upper portion comprises an interior portion that is solid and configured to define said passage and enclose a portion of a jack shaft.

5. The pest deterrent device according to claim 4, wherein said interior portion comprises a shoulder surface disposed about said passage and configured to rest against and support said body on an adjustment pin projecting out of a jack shaft.

6. The pest deterrent device according to claim 5, wherein said interior portion comprises a resilient gasket attached to wall of said upper portion or is as an integral part of said upper portion.

7. The pest deterrent device according to claim 6, wherein said passage comprises a rectangular passage configured to match and fit onto a rectangular jack shaft.

8. The pest deterrent device according to claim 6, wherein said passage comprises a square-shaped passage configured to match and fit onto a square-shaped jack shaft.

9. The pest deterrent device according to claim 6, wherein said passage comprises a cylindrical passage configured to match and fit onto a cylindrical jack shaft.

10. The pest deterrent device according to claim 4, wherein said passage is configured to fit tightly onto a jack shaft to form a friction fit.

11. The pest deterrent device according to claim 1, wherein said base portion is substantially hollow and has an inner diameter substantially greater than the diameter of said passage.

12. The pest deterrent device according to claim 1, wherein said upper portion comprises an interior portion that is solid and configured to define said passage and enclose a portion of a jack shaft.

13. The pest deterrent device according to claim 12, wherein said interior portion comprises a shoulder surface disposed about said passage and configured to rest against and support said body on an adjustment pin projecting out of a jack shaft.

14. The pest deterrent device according to claim 13, wherein said interior portion comprises a resilient gasket attached to wall of said upper portion or is as an integral part of said upper portion.

15. The pest deterrent device according to claim 1, wherein said passage comprises a rectangular passage configured to match and fit onto a rectangular jack shaft.

16. The pest deterrent device according to claim 1, wherein said passage comprises a square-shaped passage configured to match and fit onto a square-shaped jack shaft.

17. The pest deterrent device according to claim 1, wherein said passage comprises a cylindrical passage configured to match and fit onto a cylindrical jack shaft.

18. The pest deterrent device according to claim 1, wherein said passage is configured to fit tightly onto a jack shaft to form a friction fit.
